(19) United States
(12) Patent Application Publication
(10) Pub. No.: US 2016/0088164 A1
(43) Pub. Date: Mar. 24, 2016

(54) PUBLIC PAY SMART PHONE KIOSK

(71) Applicant: TTC HOLDING COMPANY, INC., Long Island City, NY (US)

(72) Inventors: JEFFREY KAPEC, Westport, CT (US); JONATHAN THAYER, Greenwood Lake, NY (US); RAYMOND MASTROIANNI, New Canaan, CT (US); HENRY H. SUNG, New Canaan, CT (US)

(73) Assignee: TTC HOLDING COMPANY, INC., Long Island City, NY (US)

(21) Appl. No.: 14/860,347

(22) Filed: Sep. 21, 2015

Related U.S. Application Data
(60) Provisional application No. 62/071,431, filed on Sep. 24, 2014.

(51) Int. Cl. H04M 17/02; H04M 3/62; H04M 1/22

(52) U.S. Cl. CPC H04M 17/026; H04M 1/22; H04M 3/62; H04W 88/16

(57) ABSTRACT

A coin operated public phone kiosk with a base member, a rectangular frame mounted on a base member, the frame comprising planar side standards, lower panels, and transparent upper panels, a phone assembly mounted to the rectangular frame above the lower panels. The phone assembly has a triangular shaped housing mounted to the frame with one side inclined inward into the frame, and a phone and keyboard mounted on the inclined side. A monitor is mounted on the kiosk frame adjacent at least one transparent upper planar panel. A cap assembly is mounted on the top of the rectangular frame and contains a solar battery.

### RELATED APPLICATIONS

This is a utility application claiming benefit and priority from U.S. Provisional Application No. 62/071,431, filed Sep. 24, 2014.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### BACKGROUND OF THE INVENTION

1. Field of Invention

The present invention generally relates to coin-operated public telephones and more particularly to an improved vandal-resistant, compact public phone installation in which a smart phone assembly is enclosed in rigid components of a support structure for maximum security and weather protection.

2. Description of the Prior Art

The prior art public telephones generally have employed a separate housing enclosing the phone, coin box, and associated equipment, with the phone dial or keypad being operated from the exterior of the housing and with the hand set, or transmitter-receiver, connected to the housing by a cord containing the required conductor elements. In such installations, the cord is conventionally encased within a flexible steel sheath in an effort to protect the instrument against vandalism. The separate housing is attached by mounting bolts to a supporting structure such as a pole, mounting plate secured to the ground or the like. Such housings generally are not weather-proof and do not provide adequate weather protection for either the enclosed equipment or the exposed components such as the hand set, with the result that a separate shield or enclosure is normally provided, either in the form of a roof, or a completely enclosed booth, both of which take up valuable urban space.

Since the coin box of conventional public phones is located within the housing enclosing the phone equipment, the delicate components of the equipment are highly vulnerable to damage by any attempt at coin theft involving forced entry into the enclosure and the housing is subject to graffiti, keying and vandalizing.

Other prior art public phone booth housings simply provide a structure for the phone instrument. The phone generates revenues from public usage which depending upon the area of use, may or may not provide a profit for the city or entity installing and/or maintaining the phone booth. Revenues derived from phones are the only revenues received from the phone installation.

The present invention envisions the use of a free standing rectangular kiosk housing the payphone which also allows advertising to supplement income and provides for public messaging. The structure also takes up reduced space due to the use of a compact housing and its components are difficult to vandalize and steal.

The following prior art shows the use of various types of kiosks providing various services to the general public.

U.S. Pat. No. 3,752,927 issued Aug. 14, 1973 discloses a telephone mount constructed with a hollow post having front and back walls spaced from one another. The front wall of the post defines an opening that conforms to the configuration of the public telephone. The interior of the post includes support means to which the public telephone is secured and blocking means above and below the support be provided that close off the interior of the post. The juncture between the front cover and the rear housing of the telephone is protected from prying tools of third parties.

U.S. Pat. No. 4,179,723 issued Dec. 18, 1979 discloses a self-contained kiosk for remote banking and credit card transactions. The kiosk has a self-supporting metal frame with a plurality of walls extending upwardly and forming a housing which includes a computer unit mounted therein. The controls for the computer unit are mounted in a recessed portion of the frame on a control panel while the functional portion of the computer is located within the housing. The base of the recessed portion forms a counter below the controls and the upper portion of the recess is equipped with suitable lighting to illuminate the controls and any advertising which might be contained on the frame itself.

U.S. Pat. No. 4,254,308 issued Mar. 3, 1981 discloses a coin-operated vandal resistant public telephone apparatus which employs one or more coin operated telephone units. The telephone equipment is enclosed within rigid components of a hollow support structure for maximum security and protection against vandalism and to enable installation and maintenance where conventional coin-operated telephones requiring separate enclosures cannot be utilized due to space limitations. A coin box is spaced away from the telephone unit at the bottom of the support structure to minimize the likelihood of damage by attempted theft.

U.S. Pat. No. 4,754,582 issued Jul. 5, 1988 is directed toward a telephone booth in which the sidewalls are box-like enclosures each having one or more advertising displays. The displays are illuminated by a light source in the interior of each enclosure which also serves to illuminate the interior of the booth.

### SUMMARY OF THE INVENTION

The present invention is directed to a coin, monetary or credit card operated public phone kiosk comprising a base member and an elongated rectangular frame mounted on the base member. The frame consists of planar side panels, a center panel located between the side panels and positioned transverse thereto, a lower base planar panel, and upper planar panel are provided on opposite sides of the frame, and a phone assembly mounted to the frame above the lower base panel in a recessed area in the frame. The phone assembly has a phone housing with a front side being inclined inward into the recess of the rectangular frame and triangular shaped sidewalls. The phone housing holds a smart phone and keyboard mounted on the inclined front side. The top of the phone housing has LED lighting to provide illumination for the telephone users. A double sided monitor is mounted on the frame between the upper planar panels which are preferably constructed of transparent glass. This provides public messages and allows for advertising of various products and services. A cap assembly is mounted on the top of the rectangular frame which carries a solar panel to charge a backup battery. A cap assembly on the frame holds a Wi-Fi antenna and a cellular antenna along with other electronic equipment such as a camera.

One object of the present invention to provide an improved public smart phone mounted within a rigid rectangular kiosk which is highly resistant to damage by vandalism.

Another object of the invention is to provide a public smart phone which is protected against the weather by the enclosing rectangular kiosk without requiring a separate weather hood or enclosure.

It is still another object of the present invention is to provide a public smart phone including transmitter and receiver apparatus mounted within the rectangular kiosk which is capable of presenting public information, safety messages and the like, artwork and advertising on the kiosk.

Another object of the invention is to provide a free-standing public smart phone installation requiring a minimum of space.

Yet another object of the invention is to provide a freestanding public smart phone which provides the public with cellular and Wi-Fi connections.

These and other objects, advantages, and novel features of the present invention will become apparent when considered with the teachings contained in the detailed disclosure along with the accompanying drawings.

### BRIEF DESCRIPTION OF THE DRAWINGS

The invention will be better understood and objects other than those set forth above will become apparent when consideration is given to the following detailed description thereof. Such description makes reference to the annexed drawings wherein.

FIG. 1 is a perspective view of a smart phone freestanding kiosk disclosed in the invention;

FIG. 2 is a front elevational view of the smart phone freestanding kiosk shown in FIG. 1;

FIG. 3 is a side cross section view taken along line 3-3 of FIG. 2;

FIG. 4 is an enlarged cross section taken from circle A of FIG. 3;

FIG. 5 is a side elevational view of FIG. 1;

FIG. 6 is a cross sectional view taken along line 6-6 of FIG. 5;

FIG. 7 is a cross sectional view taken along line 7-7 of FIG. 5;

FIG. 8 is a cross section view of taken along line 8-8 of FIG. 5;

FIG. 9 is an enlarged view taken from circle B of FIG. 8;

FIG. 10 is an exploded view of the kiosk shown in FIG. 1;

FIG. 11 is an enlarged side view of the kiosk cabinet shown in FIG. 10;

FIG. 12 is a cross sectional view taken along lines 12-12 in FIG. 11;

FIG. 13 is a cross sectional view taken along lines 13-13 of FIG. 11;

FIG. 14 is an enlarged bottom planar view of the base housing shown in FIGS. 1 and 13;

FIG. 15 is a perspective view of the base housing shown in FIGS. 14 and FIG. 1;

FIG. 16 is an enlarged plan view of the base plate shown in in FIG. 1;

FIG. 17 is a side elevational view of the base plate shown in FIG. 16;

FIG. 18 is an exploded view showing the relationship of the base plate, base housing and kiosk cabinet;

FIG. 19 is an enlarged top plan view of the phone housing shown in FIG. 20;

FIG. 20 is a front enlarged elevational view of the phone housing;

FIG. 21 is an enlarged rear perspective view of the phone housing shown in FIG. 20 and the coin assembly;

FIG. 22 is an exploded view of the phone housing and coin assembly shown in FIG. 21;

FIG. 23 is a reduced rear elevational view of the phone housing shown in FIG. 21;

FIG. 24 is a side elevational view of the phone housing shown in FIG. 23;

FIG. 25 is a perspective view of another embodiment of a public smart payphone kiosk;

FIG. 26 is a front elevational view of the cabinet housing of the public smart payphone kiosk shown in FIG. 25;

FIG. 27 is a cross sectional view taken along lines 27-27 of FIG. 26;

FIG. 28 is a cross sectional view taken along lines 28-28 of FIG. 26;

FIG. 29 is a front perspective view of the cabinet housing of FIG. 25;

FIG. 30 is an exploded view of the public smart payphone kiosk shown in FIG. 25;

FIG. 31 is an exploded view of the phone components assembly in the public smart payphone kiosk of FIG. 25 and the cap assembly;

FIG. 32 is a wiring schematic for the public smart payphone of FIG. 1 and FIG. 25.

### DESCRIPTION OF THE INVENTION

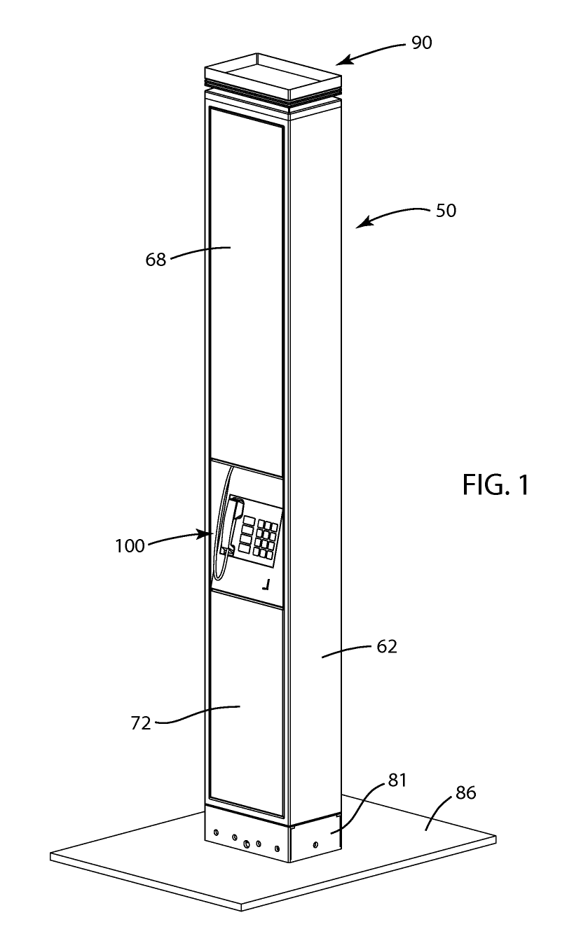

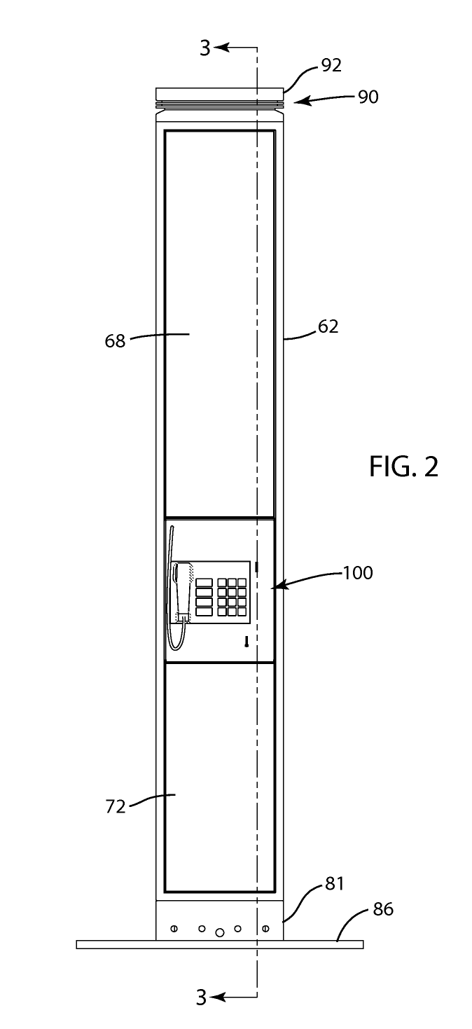

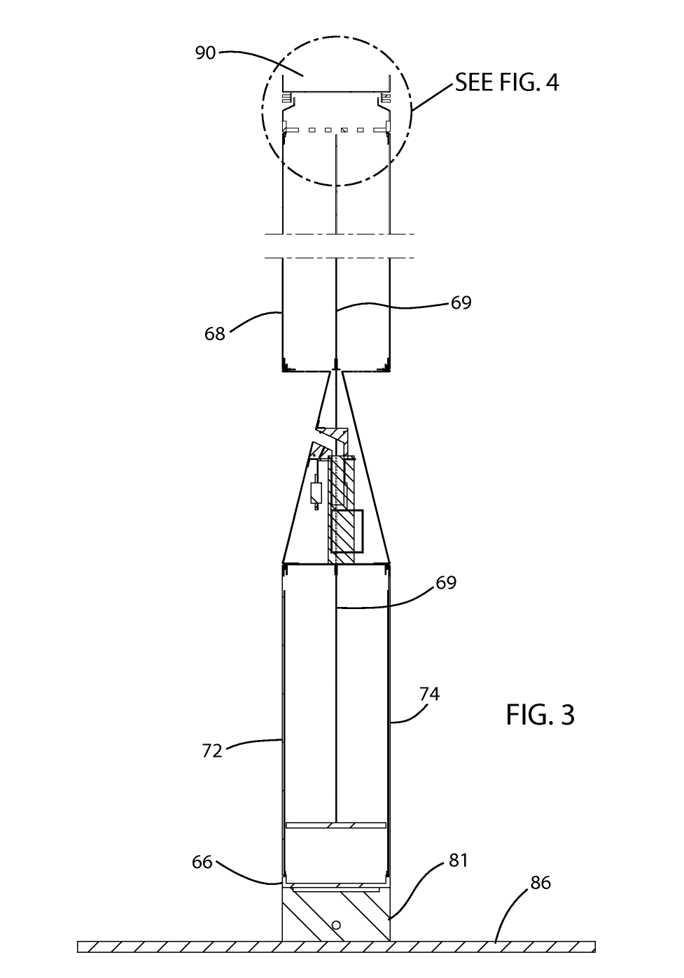

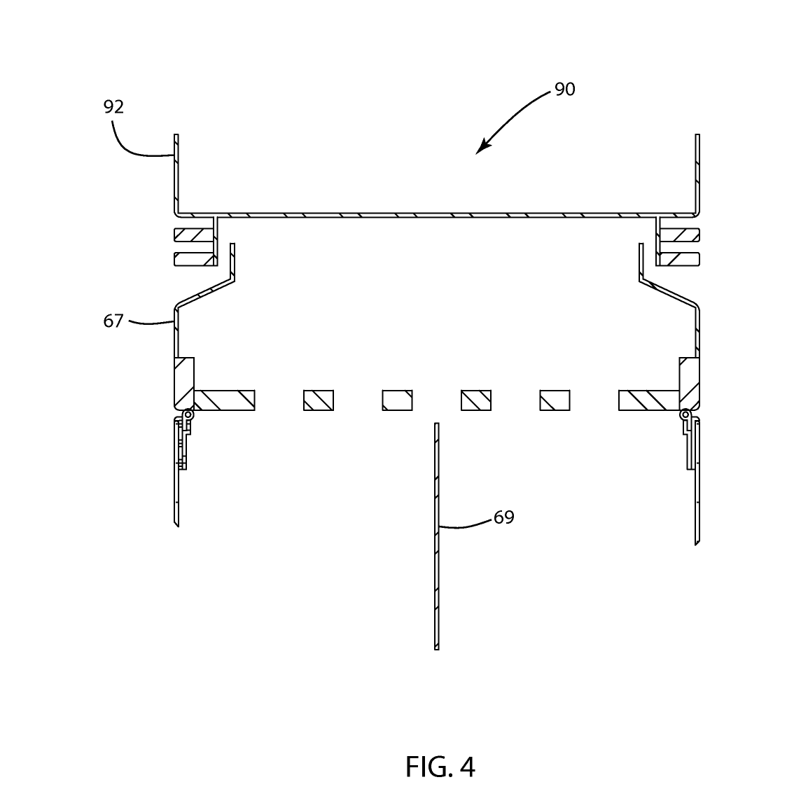

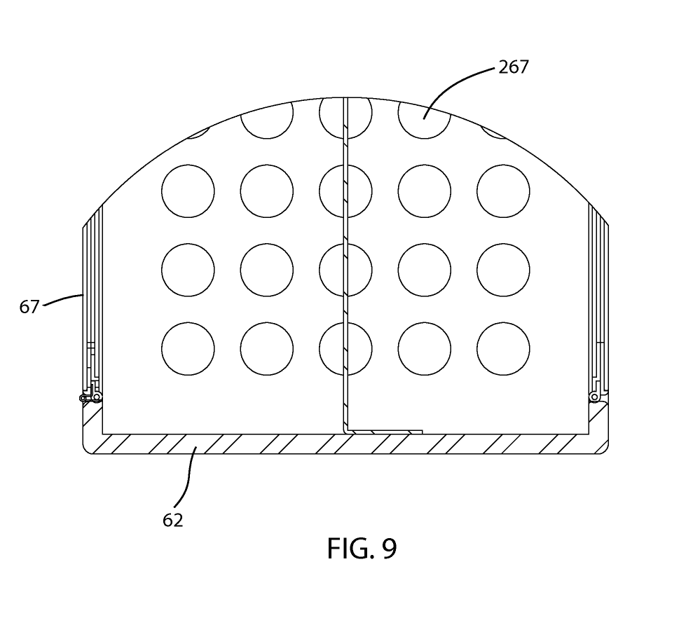

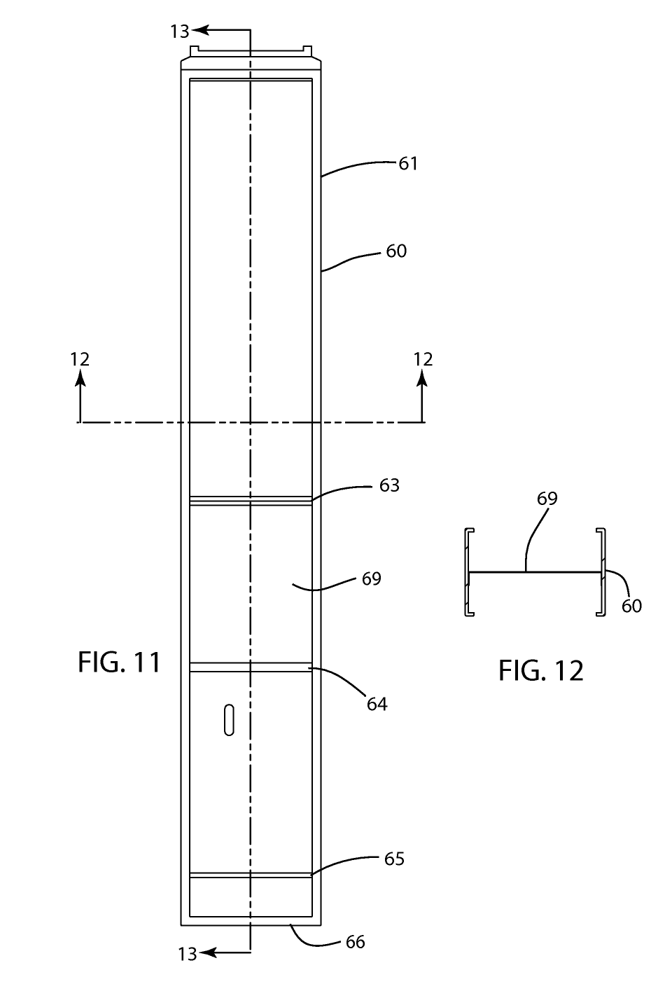

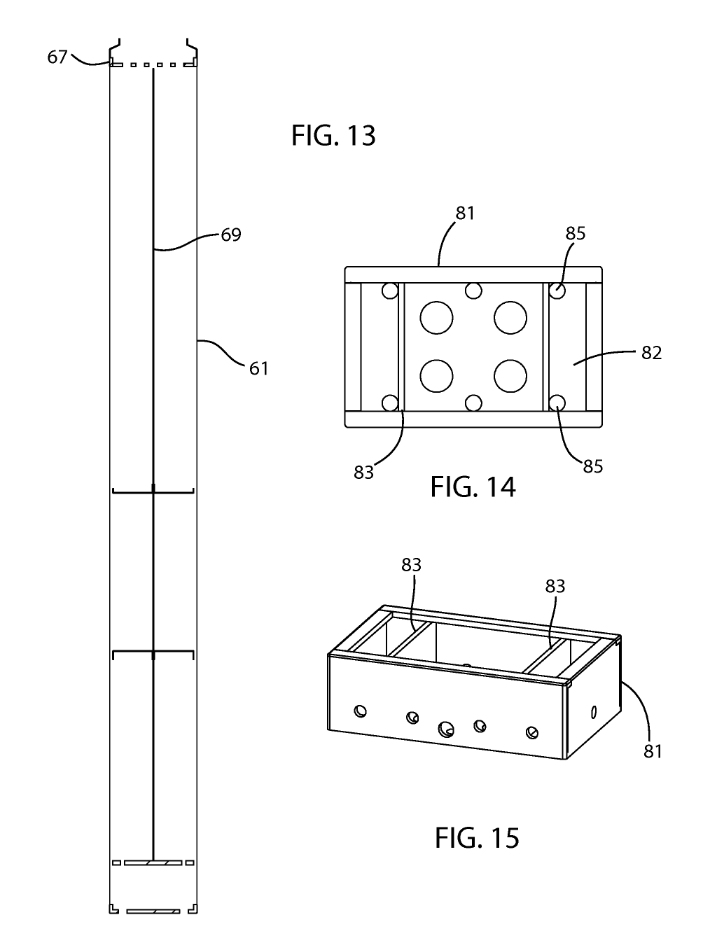

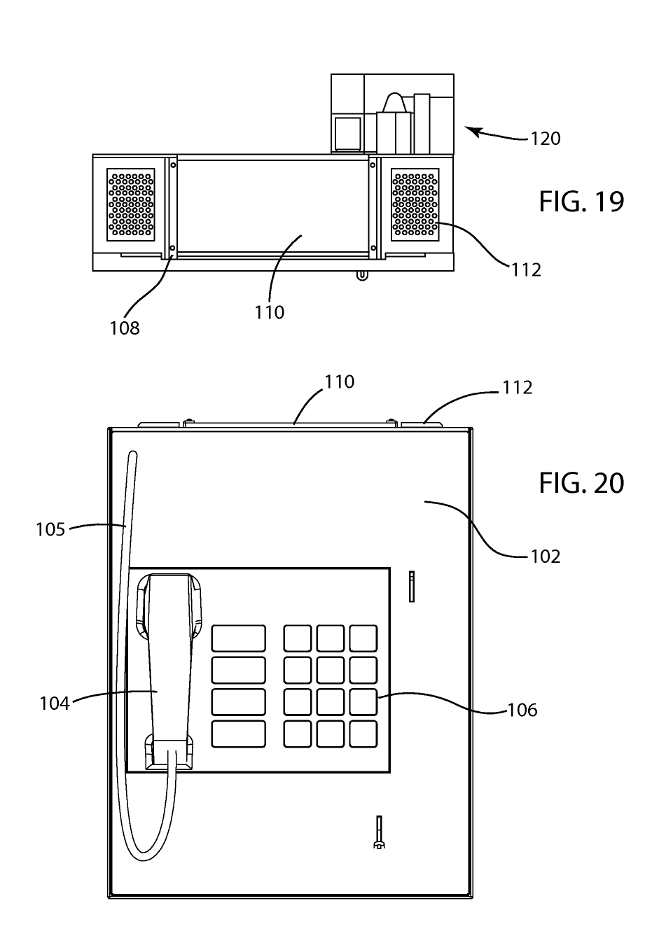

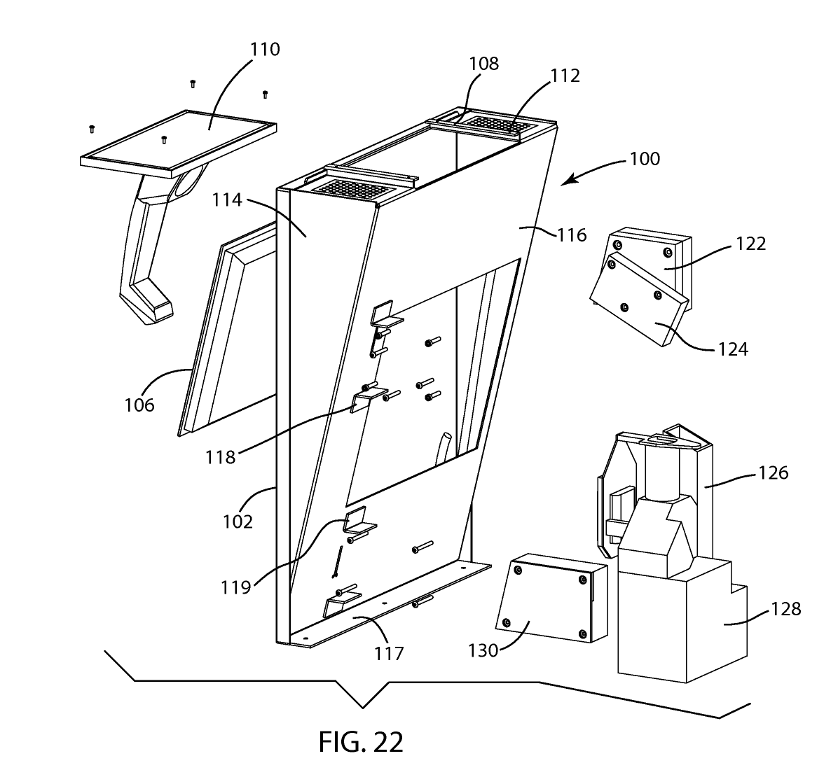

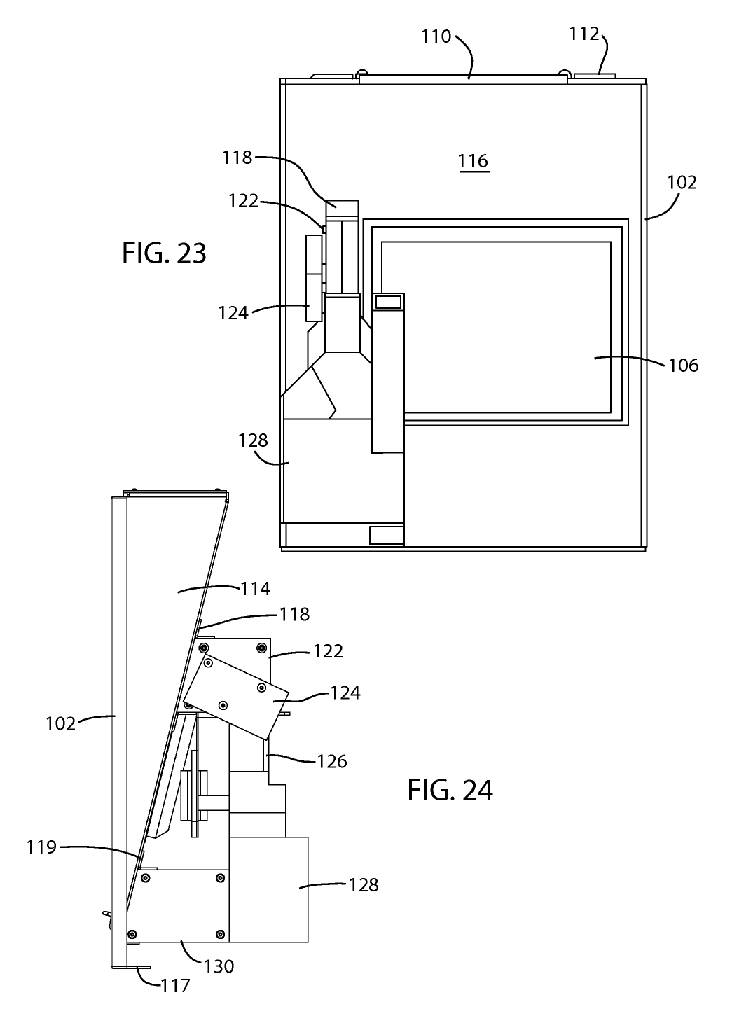

The present invention is directed towards a public smart phone free standing kiosk and the preferred embodiment and best mode of the invention is shown in FIGS. 1-24 and 32.

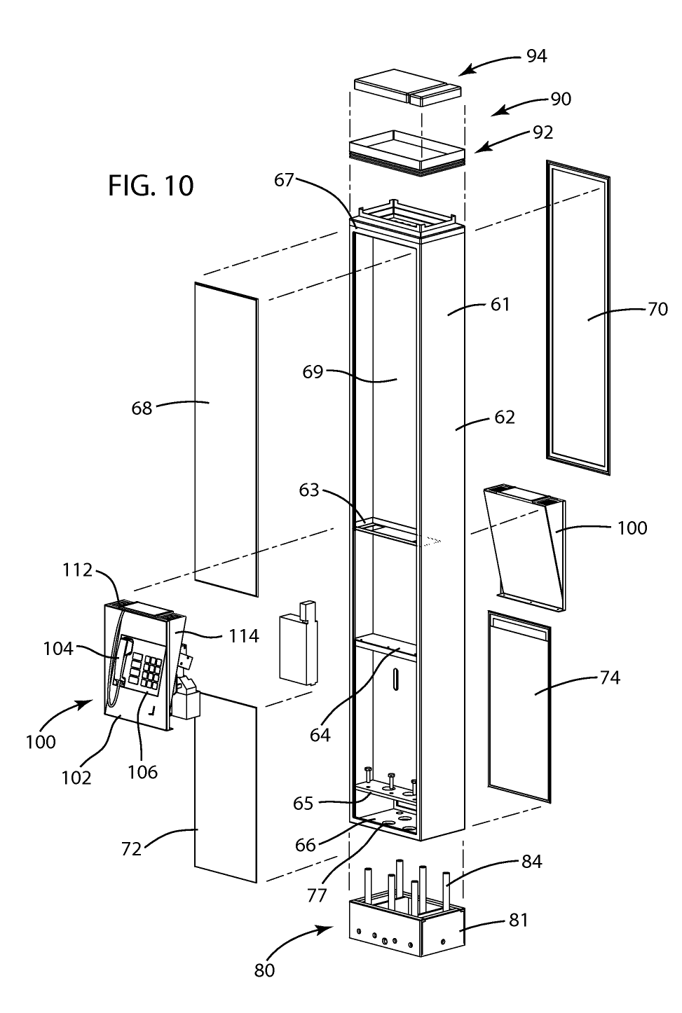

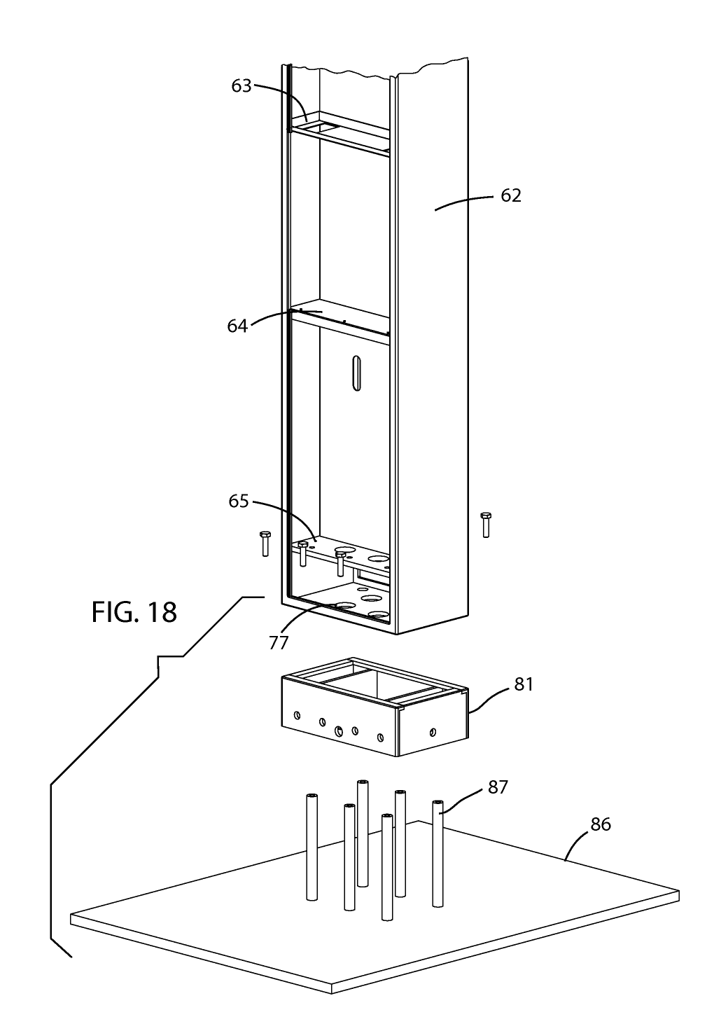

The invention comprises a commercial telephone kiosk 50 as shown in FIGS. 1-24 and 32 with frame 61 shown in FIGS. 1 and 10. The kiosk 50 is constructed with a cabinet 60 provided with a rectangular frame 61 as best seen in FIG. 10, preferably constructed of stainless steel, the frame 61 having sidewalls or standards 62, an interior upper cross support member 63 spot welded to the sidewalls 62 and positioned transverse to sidewalls 62, a lower cross support member 64 also positioned transverse to said sidewalls, and also spot welded to the sidewalls 62 and a lower base cross member 65 transversely positioned between the upright standards (sidewalls 62) of the frame 61. The base of the frame 61 is a planar base cross member 66 having a plurality of throughgoing apertures 77 which fit over threaded pins 84/87 respectively held by the base assembly 80 or the support plate 86 shown in FIG. 18. A recessed phone housing 100 fits the recess formed in the frame between cross members 63 and 64 as seen in FIG. 10. A top plate 67 formed with a plurality of apertures 267 is secured to the top of the side standard 62. A center planar support member 69 divides the cabinet chamber into halves with the opposite half of the cabinet being constructed identical to the front half shown in FIG. 10. A front upper transparent GORILLA® (a trademark of Corning Incorporated) glass panel 68 is mounted to the rectangular frame 61 and is used to hold or present advertising or public information generated from a monitor if such is used within the frame, graphics and artwork if a monitor is not used, and a rear upper panel 70 is mounted on the opposite side of the rectangular frame 61. In some usages, there would be no monitor and advertising art work or graphics would be shown protected by GORILLA® glass. A front lower panel 72 is mounted to the front of the frame 61 below the phone housing 100 and a rear lower panel 74 is mounted opposite the front lower panel 72 on the frame 61. Thus, lower panels 72 and 74 can hold advertising, art work or graphics and can be constructed of GORILLA® glass to display same as the upper panels 68 and 70. Optionally, either or both of the lower panels and/or upper panels can be constructed of steel.

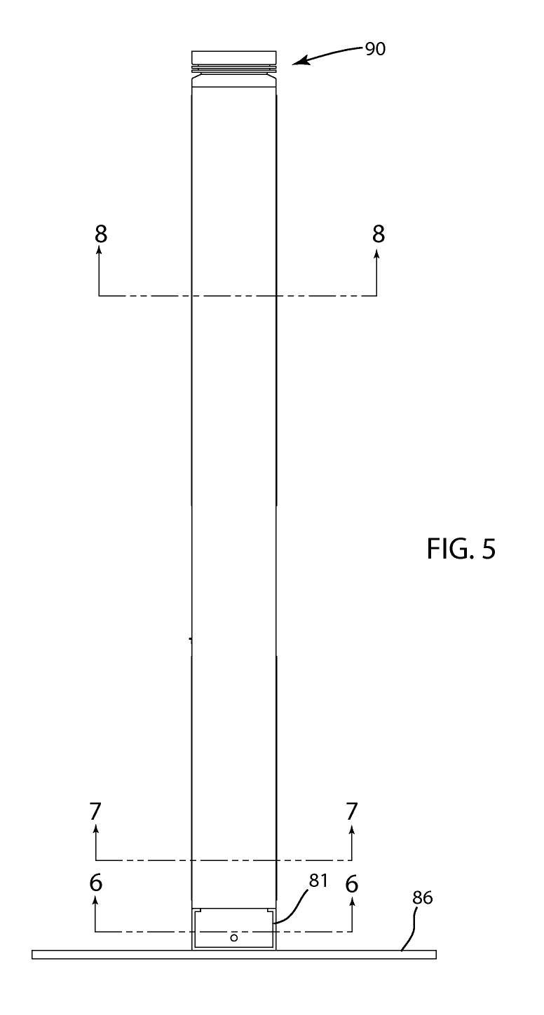

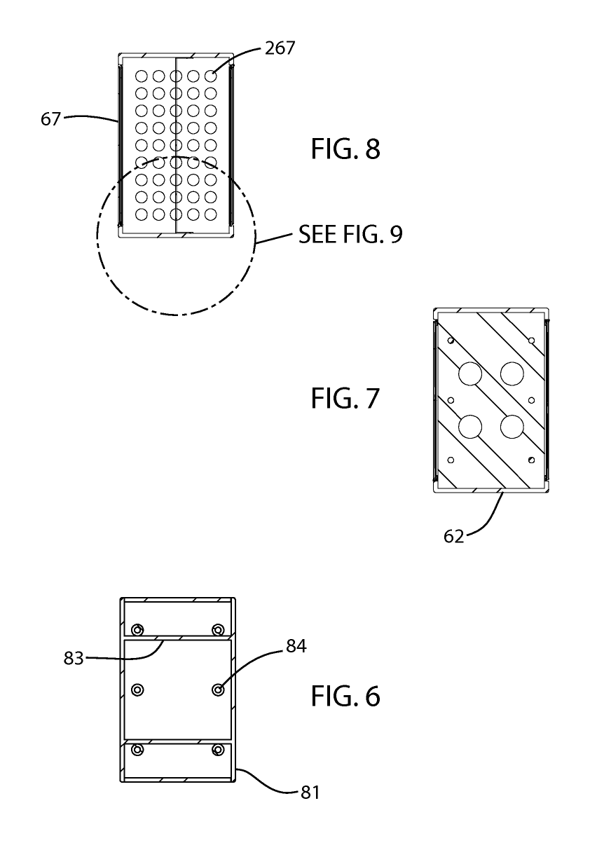

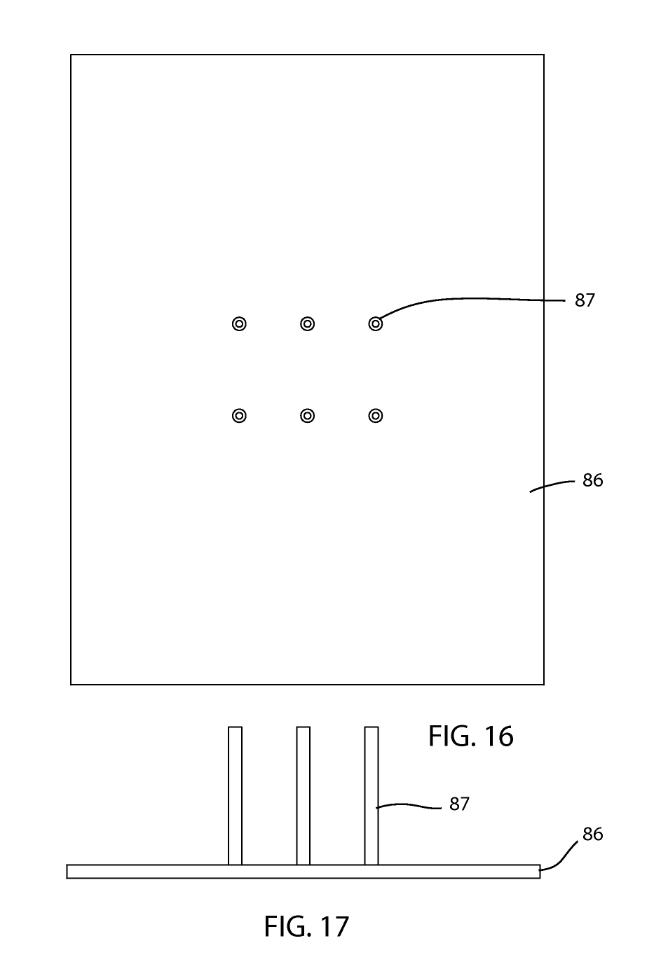

In FIG. 10, the frame 61 sits upon a base assembly 80 which is constructed with a rectangular frame 81 having cross support members 83, as seen in FIG. 6. The base assembly 80 has threaded cylindrical pins 84 extending vertically away from the frame 81. These are mounted through holes 77 cut in the base plate member 66 and are secured to the base assembly with threaded nuts. If desired, the base assembly can be seated on a support plate 86 as shown in FIGS. 5 and 16-18. As shown in FIGS. 16-18, the threaded pins 87 are mounted to a base plate 66. In this embodiment, base assembly frame 81 has a base plate 82 with a plurality of apertures 85 as shown in FIG. 14 to receive threaded pins 87.

The upper part of the kiosk frame 61 has a cap assembly 90 provided with a mounting frame 92 which is seated on the top plate member 67 as shown in FIGS. 1 and 10 and a cap member 94 which is mounted on the mounting frame 92.

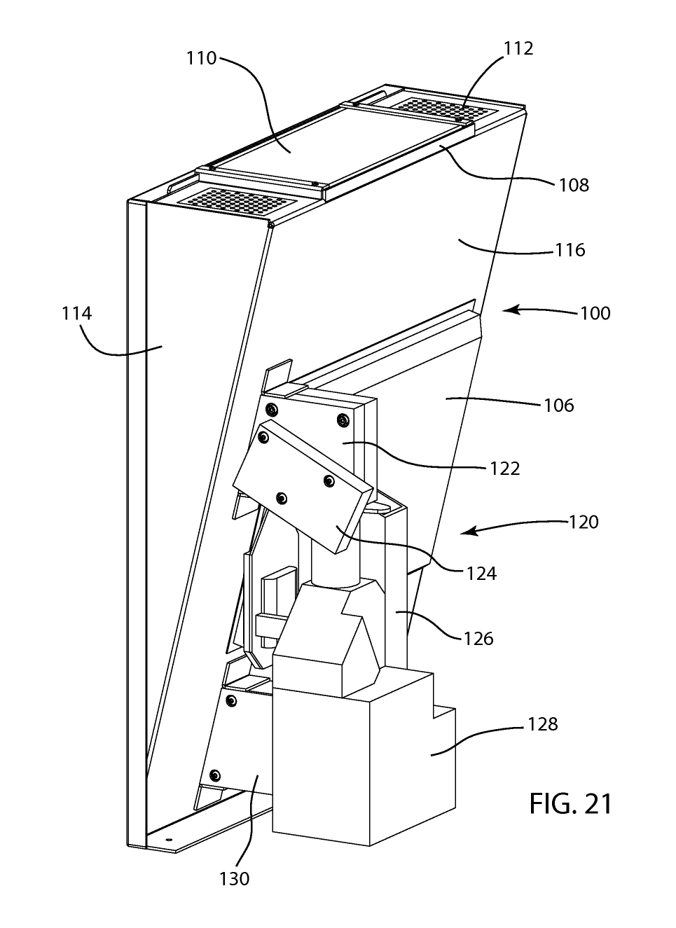

A smart phone assembly 100, as shown in FIGS. 10 and 19-24, is mounted in the inside of the rectangular frame 61 between cross support member 63 and 64. The phone assembly 100 comprises a housing 102 holding a smart phone 104 and a stainless steel reinforced cord 105. A keypad 106 is provided for operating the smart phone and panel light housing 108 provides lighting with LED panel 110. As shown in FIG. 19, each side of the panel light housing 108 are provided with side perforated panels 112 which serve to provide cooling for the interior electronics. Alternatively, a fan can be mounted on the top for cooling the LED. The housing 102 has two triangular shaped side panels 114 and a rear panel 116 secured to the rear edges of the side panels 114 to form an isosceles triangle as seen in FIGS. 21, 22 and 24. Mounting bracket 117 extends away from the rear panel 116 allowing the housing 102 to be mounted on cross member 64. Perforated panels 112 are mounted to the base of side panels 114 and the end of rear panel 116.

A coin handling assembly 120, as shown in FIGS. 21-24, is mounted to the phone assembly housing 102 and is used to activate the same. The coin handling assembly 120 consists of a coin feed box 122 mounted to housing 102, a coin validation mechanism 124 mounted to the coin feed box 122 which assures that the proper amount of money has been inserted for the call or information requested. The coin feed box 122 is mounted to brackets 118 extending from rear panel 116 and an escrow box 126 which holds the money and a safe box 128 mounted to the coin return mechanism 130 as shown in FIGS. 21-24 into which the coins are deposited when the call is finished. The coin return mechanism 130 is mounted on brackets 119 extending from rear panel 116 provides for return of money on calls that are not made and for change. If desired, a bill reader can also be used to allow use of paper monies.

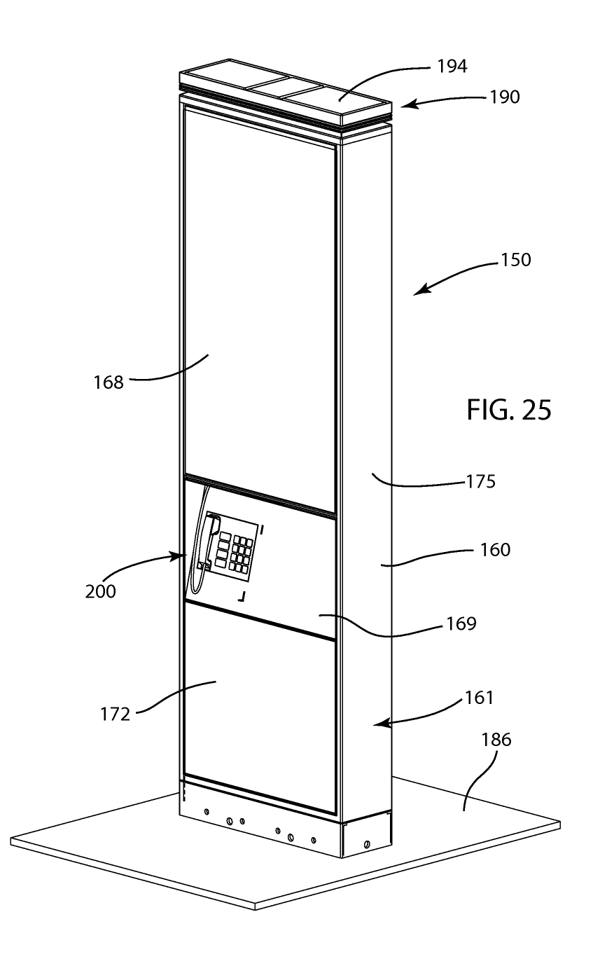

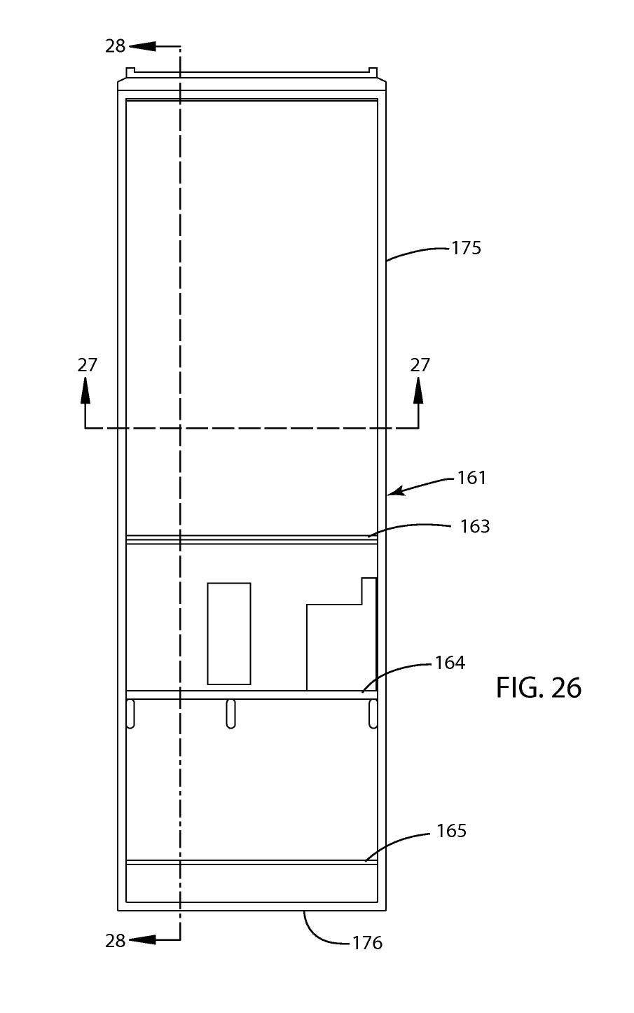

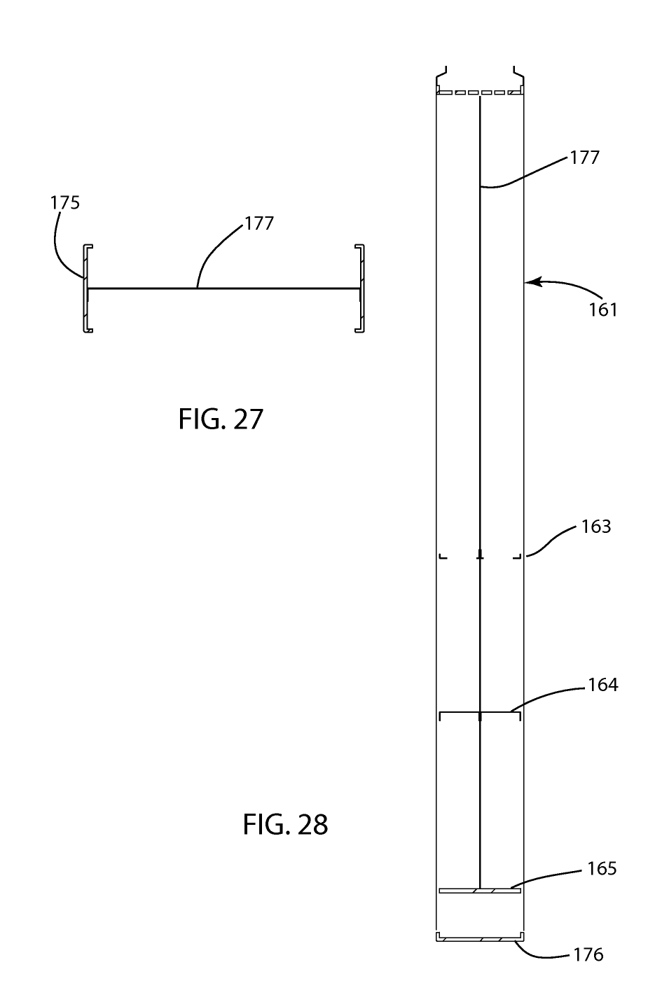

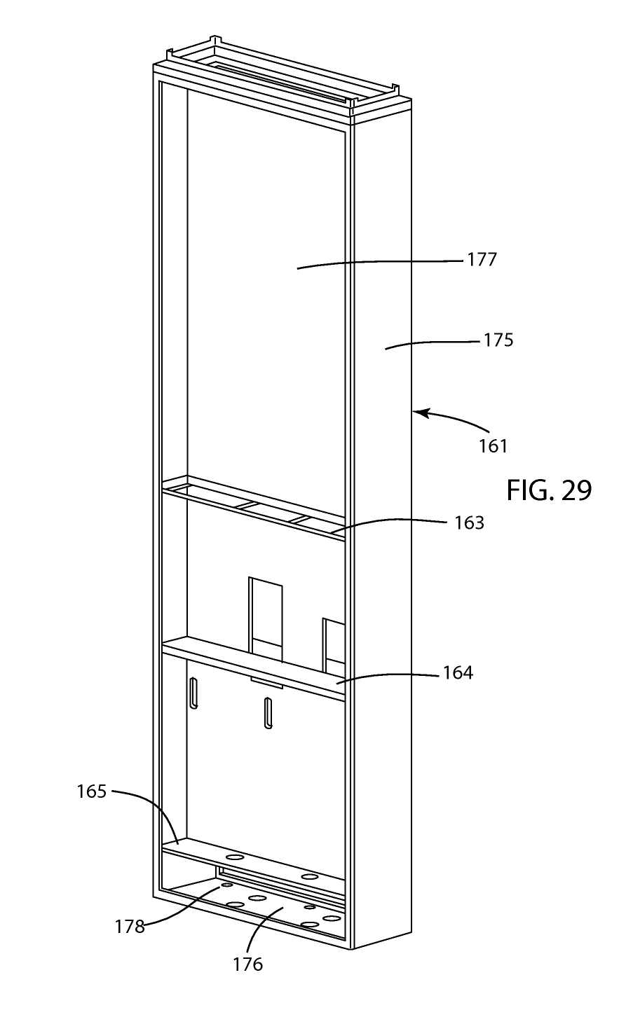

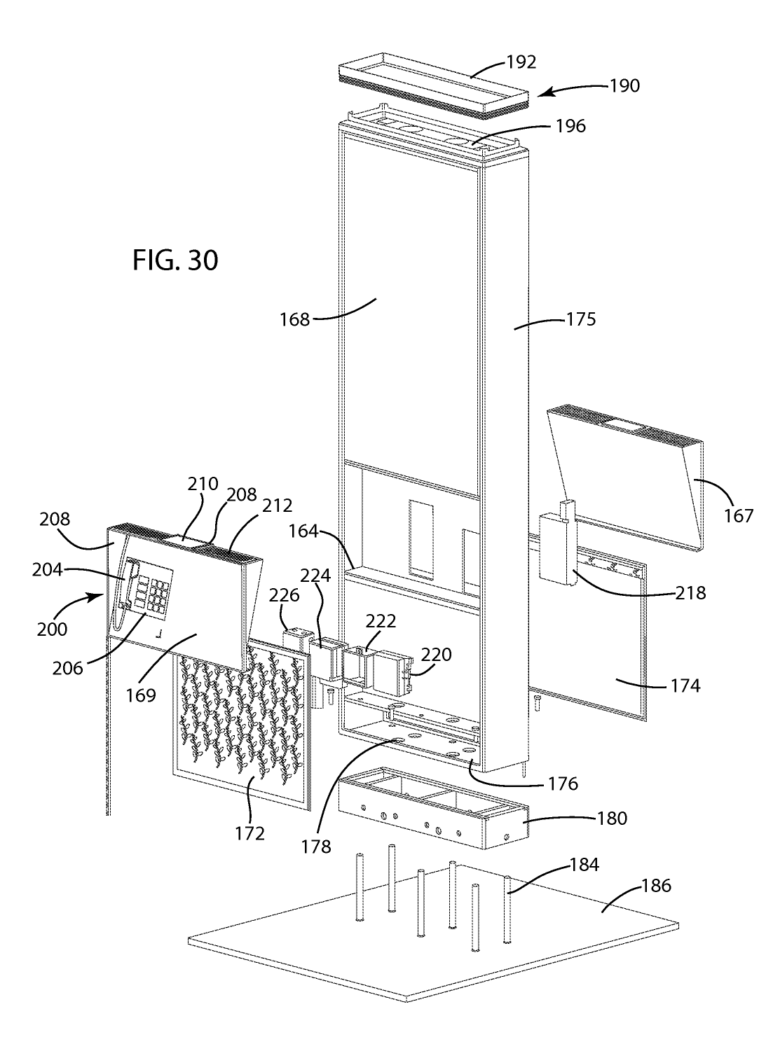

Another commercial telephone kiosk embodiment is shown in FIGS. 25-32. This embodiment comprises a commercial phone kiosk 150 which is constructed with a cabinet 160 provided with a rectangular frame 161. The frame 161 as seen in FIGS. 26-29 has upright standards or sides 175 with an interior intermediate cross support member 163, a lower cross support member 164 and a lower base support member 165 horizontally positioned between the upright standards 175 of the frame. The base of the frame 161 has a planar base plate member 176 provided with throughgoing apertures 178 as seen in FIGS. 29 and 30. The cross support members 163, 164, 165 and base support member 176 are secured to the upright standards 175. A center support member 177 is secured to the support members 164 and 165 and to top support as shown in FIG. 28 and provides the rear panel for the smart phone assembly housing 167. The smart phone support housing 167 fits between cross members 163 and 164. A front upper panel 168, preferably constructed of glass, is mounted to the rectangular frame 161 and a rear upper panel (not shown) which is equivalent to upper panel 70 is mounted opposite upper panel 168 on the opposite side of the rectangular frame 161. A front lower panel 172 is mounted to the front of the frame 161 and a rear lower panel 174 is mounted opposite the front lower panel 172 on the frame 161 as shown in FIG. 30. These front and rear panels can be static, illuminated or have artwork behind the panels. They are preferably constructed of GORILLA® glass manufactured by Corning Incorporated. The side standards 175 extend vertically providing height of the frame 161 with the base plate 176 forming the base of the frame 161. The frame 161 sits upon a base assembly 180 which is constructed with a rectangular frame as shown in FIG. 30. The base assembly 180 can be seated on plate 186 having cylindrical threaded pins 184 extending away from the plate which are mounted in holes cut in the base assembly 180 and through holes 178 cut in the base 176 as shown in FIG. 30.

The upper part of the kiosk has a cap assembly 190 provided with a housing frame 192 which is seated on the top of an LG5500 double sided monitor 195 (not shown) positioned between upper panel 168 and the rear upper panel to provide back to back digital displays with camera, for advertising and municipal messages. The bottom of monitor holds an inductive charger 209 which is used to provide wireless charging of personal electronic devices of the users. Frame 192 houses an LED beacon, solar panel, cellular antenna and Wi-Fi access antenna. Wi-Fi cap member 194 is mounted on the mounting frame.

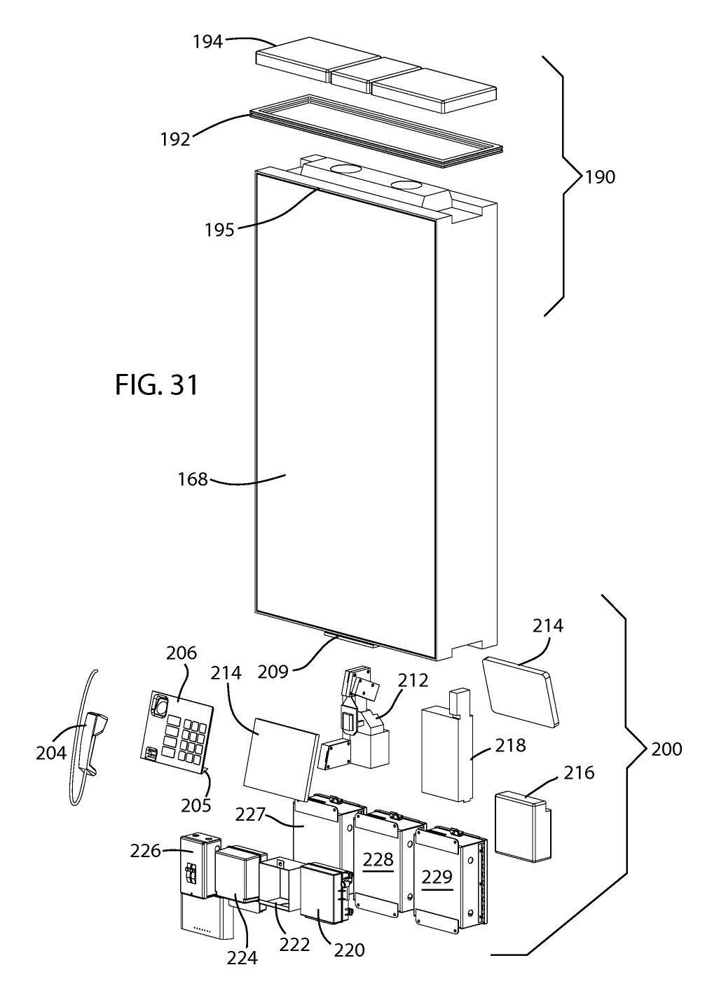

A smart phone assembly 200 shown in exploded view in FIG. 30 is mounted in the inside of the rectangular frame 161 below the front upper panel 168 and above the front lower panel 172 on the inclined front plate surface 169 of triangular housing 167. The smart phone assembly 200 comprises the housing 167 holding a smart phone 204, a keypad 206 with key pad arm 205 provided for operating the smart phone and a LED panel 210 having a 4″×8″ high output which provides illumination of the adjacent sidewalk. An inductive charger 209, shown in FIG. 31, allows for wireless charging of personal devices. Panel light housing 208 provides lighting with LED panel 210. On each side of the panel light housing 208 are provided side perforated panels 212 which serve to provide cooling for the lighting as shown in FIG. 30.

Tablet 214, as shown in FIG. 31, is a 10″ android type tablet with capacitive GORILLA® glass which acts as an information touch screen. This is located on the opposite side from keypad 206. A power stream battery 216 serves as a backup power source for the tablet. This backup is a lithium iron phosphate deep cycle 19.8 or larger A4 battery. Box 218 is a Phone PCB. Also located in the frame is box 220 which is a phone network box, e.g., a wire function box and Box 222 is an IDF Box which is a Con Edison Service Junction Box.

Box 224 is a meter box and Box 226 is a Square D Box with 2×20 amp AC surge suppression. Meter boxes 227, 228 and 229 allow each unit is to be individually metered.

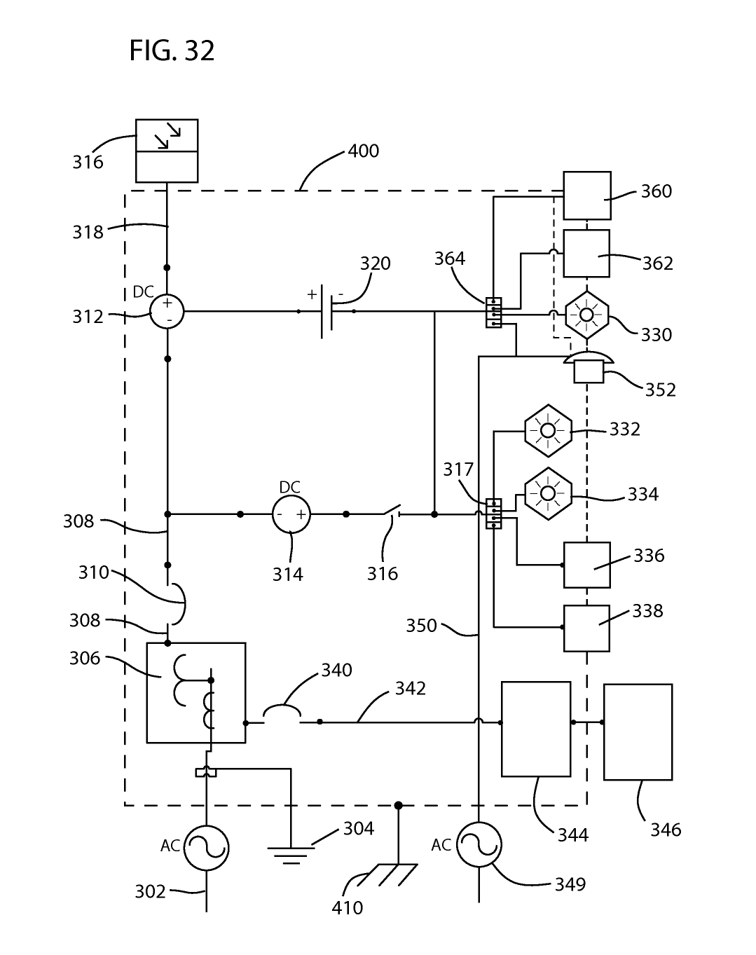

FIG. 32 discloses the wiring schematic 300 and electronics for the public smart payphone. Power in the form of alternating current is delivered through power line 302 with an earth ground 304 to a 110 volt alternating current (VAC) meter box 306. The meter box 306 delivers power through line 308 having a surge suppressor breaker 310 to a DC charger 312 and a AC/DC 12 V DC converter 314. The DC charger 312 transmits power to a 12 V DC battery 320 and receives power from solar panel 316 through line 318. The 12V DC battery 320 stores electricity for transmission of power to top LED 330, LED 332 and LED 334 when there is a power shortage and smart phone 352. Switch 315 allows a switch to power from battery 320 when there is a power outage under normal conditions. The AC/DC 12V DC converter 314 transmits power to a top LED 330, LED Panel A 332 LED Panel B 334, inductive charger 336 and touch screen 338. As noted, an inductive charger 336 and an information touchscreen 338 preferably using android software area connected to both power sources. The 110 VAC meter box 306 also transmits power along surge suppressor breaker 340 on line 342 to an LG Dual Display with camera 344 and an optional Light box 346. The LG Dual Display 344 and optional light box are not connected to the battery 320 power source. Telecom in 349 is transmitted along line 350 to smart phone 352. Signals from cellular antenna 360 and WIFI antenna 362 are linked via conversion box 364 to smart phone 352. The housing is shown by dotted line 400 which is physically connected to a chassis ground 410. Preferably, the solar panel 316, cellular antenna 360 and Wi-Fi antenna 362 are located on the top of the kiosk housing 400.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What is claimed is:

1. A public phone kiosk comprising a base assembly, a rectangular frame mounted on said base assembly, said frame comprising a base member mounted to said base assembly, planar side standards secured to said base member, a plurality of cross support members mounted to said standards and a top member secured to said side standards, a phone assembly mounted in a recess formed in said frame above said lower base panel, said phone assembly comprising a housing mounted to said frame with a side of said housing being inclined inward into said frame, and a telephone assembly comprising a smart phone and keyboard mounted on said inclined side, upper planar panels mounted to said frame above said telephone assembly opposite each other and lower panels mounted to said frame below said telephone assembly opposite each other.

2. A public phone kiosk as claimed in claim 1 wherein said base assembly comprises a support plate, a plurality of cylindrical support pins mounted to said support plate extending transverse from said support plate and a rectangular base housing seated on said support plate and mounted to said plurality of support pins.

3. A public phone kiosk as claimed in claim 1 wherein a cap assembly is mounted said top member of said rectangular frame, said cap assembly comprising a cap mounting frame and a cap member mounted to said cap mounting frame.

4. A public phone kiosk as claimed in claim 1 wherein a coin handling assembly is mounted to said phone assembly and housed within said frame, said coin handling assembly comprising a coin feed box, a coin validation mechanism which assures that a proper amount of money has been inserted, an escrow box, a safe box holding coins after services have been provided and a coin return mechanism.

5. A public phone kiosk as claimed in claim 1 wherein a solar panel is mounted to said frame, said solar panel being electrically connected to a storage battery housed in said frame to store electrical energy generated by said solar panel, said battery transmitting electrical energy to electrical components housed within and mounted to said frame when the main source of power is interrupted.

6. A public phone kiosk as claimed in claim 1 wherein at least one monitor is mounted on said kiosk frame above said lower panels.

7. A public phone kiosk as claimed in claim 1 wherein said vertical support member is mounted in said frame transverse to said side standards.

8. A public phone kiosk as claimed in claim 1 wherein said upper panels are transparent hardened glass.

9. A public phone kiosk as claimed in claim 3 wherein said cap assembly contains a cellular antenna and a Wi-Fi antenna.

10. A public phone kiosk as claimed in claim 1 wherein said frame contains a LED panel above said telephone assembly which illuminates the surrounding area.

11. A public phone kiosk as claimed in claim 1 wherein said frame has a tablet with capacitive hardened glass which acts as an information touch screen.

12. A coin operated public phone kiosk comprising a base member, a rectangular frame mounted on said base member, said frame comprising planar side standards, a base secured to said standards, a plurality of cross support members secured to said standards and a top member secured to said standards, a plurality of lower base panels are mounted to said side standards opposite each other, and a plurality of transparent upper panels are mounted to said side standards opposite each other, at least one phone assembly is mounted on a cross support member above said lower base panels, said telephone assembly comprising a telephone housing mounted to said frame with one side of said housing being inclined inward into said frame, a smart phone and keyboard mounted on said inclined side, a double sided monitor is mounted on said frame between said upper transparent planar panels allowing presentation of advertising and public service messages from said monitors through said upper panels, a cap assembly is mounted on the top of said rectangular frame, said cap assembly comprising a cap mounting frame, at least one solar panel mounted to said cap mounting frame and a cap member mounted to said cap mounting frame.

13. A coin operated public phone kiosk as claimed in claim 12 wherein said vertical support member is mounted in said frame transverse to said side standards.

14. A coin operated public phone kiosk as claimed in claim 12 wherein said cap assembly houses a cellular antenna and a Wi-Fi access antenna.

15. A coin operated public phone kiosk as claimed in claim 12 wherein said telephone housing contains a LED panel which illuminates the surrounding area.

16. A coin operated public phone kiosk as claimed in claim 12 wherein a coin handling assembly to operate said telephone assembly is mounted to said phone assembly and housed within said frame, said coin handling assembly comprises a coin feed box, a coin validation mechanism which assures that a proper amount of money has been inserted, an escrow box, a safe box holding coins after telephone services have been provided and a coin return mechanism.

17. A coin operated public phone kiosk as claimed in claim 12 wherein an electrical storage battery is mounted to and housed within said rectangular frame, said battery being charged by direct current generated by said at least one solar panel.

18. A coin operated public phone kiosk as claimed in claim 12 wherein said double sided monitor is mounted on said frame between said upper transparent planar panels and is programmed to produce and display video advertising and receive an display public messages.

19. A coin operated public phone kiosk comprising a base member, a rectangular frame mounted on said base member, said frame comprising planar side standards, and center standard positioned transverse to said side standards and secured to said side standards, upper transparent panels mounted to said frame opposite each other, a base assembly secured to said standards, a plurality of cross support members secured to said side standards, a cap assembly mounted on said side standards, a telephone assembly comprising a telephone housing mounted in a recess defined by said frame and a telephone and keyboard mounted on said housing, a coin handling assembly to operate said telephone assembly is mounted to said phone assembly and housed within said frame, said coin handling assembly comprises a monetary feed box, a monetary validation mechanism which assures that a proper amount of money has been inserted, a safe box holding deposited money after telephone services have been provided and a money return mechanism, a double sided monitor is mounted on said frame between said upper planar transparent panels, an electrical storage battery is mounted to and housed within said frame, said battery being charged by direct current from an outside power source and current from a solar panel mounted to said frame, circuit means to provide a telephone signal and power distribution mounted in said frame and at least one LED panel connected to said circuit means.

20. A coin operated public phone kiosk as claimed in claim 19 wherein said cap assembly houses a cellular antenna and a Wi-Fi access antenna.

21. A coin operated public phone kiosk as claimed in claim 19 wherein said telephone housing is triangularly shaped.
